(19) United States
(12) Patent Application Publication
(10) Pub. No.: US 2012/0192092 A1
(43) Pub. Date: Jul. 26, 2012

(54) SYSTEMS AND METHODS FOR BUILDING COMPLEX DOCUMENTS EMPLOYING FEEDFORWARD INDICATORS

(76) Inventors: David Neil Slatter, Bristol (GB); Darryl Greig, Bristol (GB); Andrew Hunter, Bristol (GB)

(21) Appl. No.: 13/013,619

(22) Filed: Jan. 25, 2011

(51) Int. Cl. G06F 3/048

(52) U.S. Cl. 715/769; 715/764

(57) ABSTRACT

Systems and methods are provided for building a complex document. A system can include a memory for storing computer executable instructions and a processing unit for accessing the memory and executing the computer executable instructions. The computer executable instructions can include a graphical user interface engine to display a complex document and to display a feedforward indicator associated with an element in the complex document in response to a first user operation. The feedforward indicator provides a user with an indication of affects to the complex document associated with a second user operation.

### BACKGROUND

Tools exist for building documents. One such tool for the creation of photo books, greeting cards, calendars and posters features a template approach where each template supports a small number of layout variants. Various decorative themes are available through menus and sidebars. The tool utilizes a single document model and provides interface modes that allow a user to choose from predefined content and content attributes. Other tool employ complex interfaces may require detailed knowledge of the tool to build documents.

### BRIEF DESCRIPTION OF THE DRAWINGS

FIG. 1 illustrates a block diagram of an example graphical user interface for building complex documents.

FIG. 2 illustrates a block diagram of an example of a complex document.

FIG. 3 illustrates a block diagram of an example system for building of complex documents employing feedforward indicators.

FIG. 4 illustrates an example of a multi-level hierarchical data structure associated with a spread.

FIG. 5 illustrates an example of a feedforward indicator during a user pointing operation to an element of a complex document.

FIG. 6 illustrates an example of a feedforward indicator during a user drag operation of an element.

FIG. 7 illustrates an example of a feedforward indicator during a user move operation to move elements within an open space in the target complex document.

FIG. 8 illustrates the resultant GUI after a user drop operation subsequent to the user drag operation of FIG. 7.

FIG. 9 illustrates an example of a feedforward indicator during a user pointing operation to a group of elements of a complex document.

FIG. 10 illustrates an example of a secondary feedforward indicator during a user drag operation of a feedforward indicator of a group of elements.

FIG. 11 illustrates an example of a secondary feedforward indicator during a user drag operation of a feedforward indicator of an element.

FIG. 12 illustrates an example of selecting elements that are normally covered by other elements.

FIG. 13 illustrates a flow chart of an example method for building a complex document employing feedforward indicators.

### DETAILED DESCRIPTION

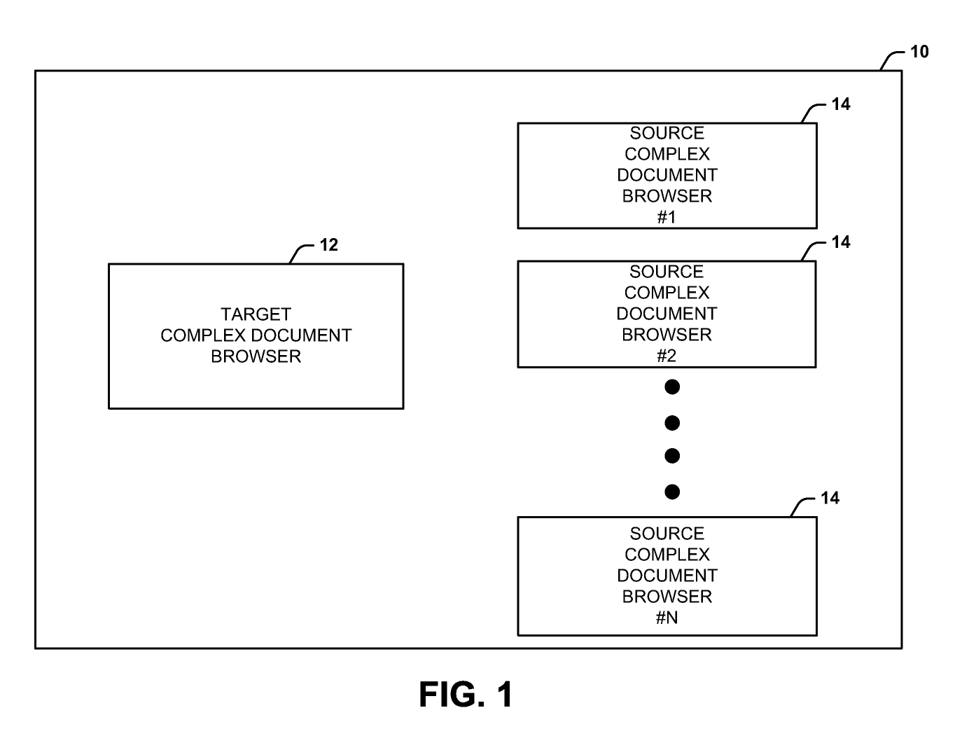

FIG. 1 illustrates a schematic diagram of an example graphical user interface 10 for building complex documents. The graphical user interface (GUI) 10 includes a single user interface window 16 that includes a target complex document browser 12 and a plurality of source complex document browsers 14, labeled source complex document browser #1—source complex document browser #N, where N is an integer greater than equal to one. Displayed within the target complex document browser 12 and each of the plurality of source complex document browsers 14 is an associated complex document. As used herein, a complex document refers to a document that contains a group of elements selected from the group comprising text elements, graphical elements and image elements residing in containers with associated layout formats. An image element is a pixel array, such as, for example, a photo. A graphical element can be a pixel array but may often have a vector representation (including scalable vector graphics (SVG)) associated with the graphical. The vector representations are readily scalable without the loss of quality. Graphical elements can be used for borders and decoration, logos, diagrams, etc. A text element can be a block of text, or a text header. Text of a header can include an emphasis such as large text, bolding, underlining, etc. and a tag to identify that it is to be put at a top of a layout or first in a layout. The layout of these elements is fully two dimensional, such that it is not restricted to folding a one dimensional thread of characters and images into a fixed column or page. A complex document can also comprise layouts of layouts.

As used herein, the term “includes” means includes but not limited to, the term “including” means including but not limited to. The term “based on” means based at least in part on.

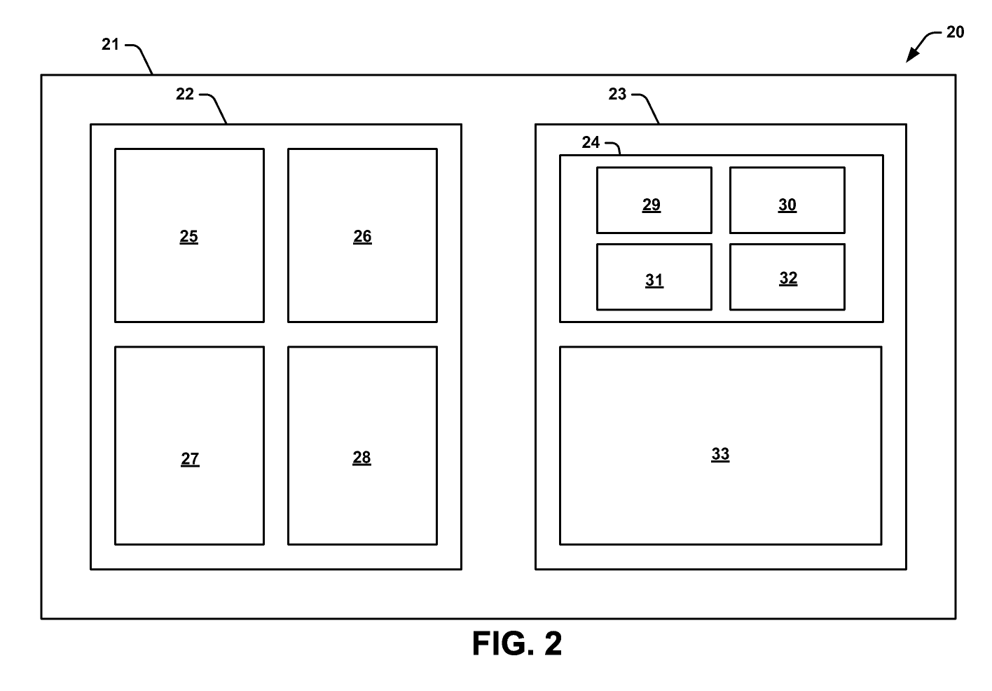

FIG. 2 illustrates an example block diagram of a complex document 20. The complex document 20 includes image elements 25-30 and text elements 31-33. Image elements 29 and 30 and text elements 31 and 32 reside within a grid type layout 24. Image elements 25-28 reside in a first page layout 22. The grid layout 24 and text element 33 reside in a second page layout 23. Pages 22 and 23 reside in a spread layout 21 containing the two pages 22 and 23. Examples of a complex document can be a magazine, a book, a newspaper, a periodical or other publishable type of document. The modifier “source” is intended to indicate that the document is to be used as a source of content. As such, the source complex document can be write-protected upon its creation, such that any part or the entire document can be copied into a target complex document without causing or allowing changes to the source complex document. The copied content can be manipulated and edited within the target complex document.

A complex document is represented for computation by a structure of elements and containers. A container is defined as a group of document elements and a layout format comprising a specific layout engine and layout parameters to be used to arrange these elements. The layout engine arranges and modifies the elements in its container to fill the shape and size of the available surface (such as but not limited to the page). Containers can include containers to support complex documents which comprise layouts of layouts. The resulting structure can be described as multi-level hierarchical. Examples of containers include pages, spreads including two facing pages, a group of images, a group of images with titles and others. The results of the container layout operation are displayed in the browser window. Individual text, graphic or image elements can be selectable by pointing to the elements. A container is selectable by pointing at a margin drawn around its elements or a gap between its elements or by a region revealed when the pointer is in the neighborhood of the container's elements. Document creation and editing is accomplished by dragging a selected element or a container on to other elements or containers. Dragging an element on to another element indicates a replace operation. Dragging an element on to a container indicates an operation to add the element to the container. After the container structures have been edited to reflect the user inputs, the container layout engines run and the new arrangement is displayed in the browser window.

An element or container can be selected and copied (e.g., via a pointer drag and drop operation) from the plurality of source complex document browsers 14 to the target complex document browser 12 to allow a user to build a new complex document. An element or container from the plurality of source complex document browsers 14 can be selected and placed over an existing element in the target complex document browser 12, which causes the existing element to be replaced by the copied element or container. A container from the plurality of source complex document browsers can be selected and placed over a container in the target complex document browser, which causes the target complex document container to use its own layout format to layout its existing elements along with the new container. The element or group of elements from the plurality of source complex document browsers 14 can be placed in open spaces corresponding to containers in the target complex document browser 12, which causes the existing elements to be placed into the target complex document associated with the target complex document browser 12.

The elements copied into the target complex document browser 12 can be edited. For example, text in the text element can be deleted and new text added by typing or copying into the text element. The font can be modified in the text element. Additionally, the elements in the target complex document can be copied and/or moved to other locations in the target complex document with existing elements being rearranged based on the layout engine of the container. The elements in the source complex document browsers 14 may be restricted such that the elements can be copied and not moved or edited in the source complex document browsers 14.

The graphical user interface 10 employs feedforward indicators in response to user operations. A feedforward indicator provides a user with an indication of results associated with a subsequent user operation. The results indicated can include what document parts are to be affected and how they are to be affected by the subsequent user operation. For example, a feedforward indicator can provide a user with an indication of which element, group of elements or containers are selected and that a subsequent user operation will copy them. Additionally, when a user is about to drop a copied element or group of elements into the target complex document, a feedforward indicator provides a user with an indication of whether the copied material replaces elements of the target complex document or is to be added to the target complex document. The feedforward indicator can also indicate which element or group of elements are replaced or added to as a result of the drop operation.

For example, moving a mouse pointer or other pointer over an element from a source complex document can cause ends of the element to curl back providing a user with an indication that the element is active and selectable for copying. A mouse down event can be employed to select the element to be dragged to a target complex document. A silhouette or shadow of the copied element can appear during the dragging of the copied element to the target complex document. At the drop position in the target document feedforward indications indicate to the user either that a replace operation or an insertion operation will follow. In the case of a replace operation, the feedforward indication includes a transient visual change, for example fading, in the element targeted for replacement. In the case of an insertion operation the appearance of the insertion target group can be temporarily changed, for example, all the target group elements rotate. In both these cases, the element replaced and the container for the insertion target group are indicated to the user by the curling back of their respective corners. Furthermore, a curled corner of a selected element can be dragged to reveal attributes of the element or group of elements, such as authorship, element type, price of using the element, etc.

A container from the plurality of source complex document browsers can be selected and placed over existing elements in the target complex document browser, which causes the container and its associated layout format to be copied to the target complex document. Feedforward indication in the case is initiated by placing a pointer over an open space or margin of the container or by selecting the corners of overlaying elements to reveal the underlying container. The corners of the container curl to indicate that the container is selected for a copy operation. The element, group of elements and/or containers can be copied from the plurality of source complex document browsers 14 and can be placed in open spaces in the target complex document browser 12, which causes them to be placed into the target complex document associated with the target complex document browser 12.

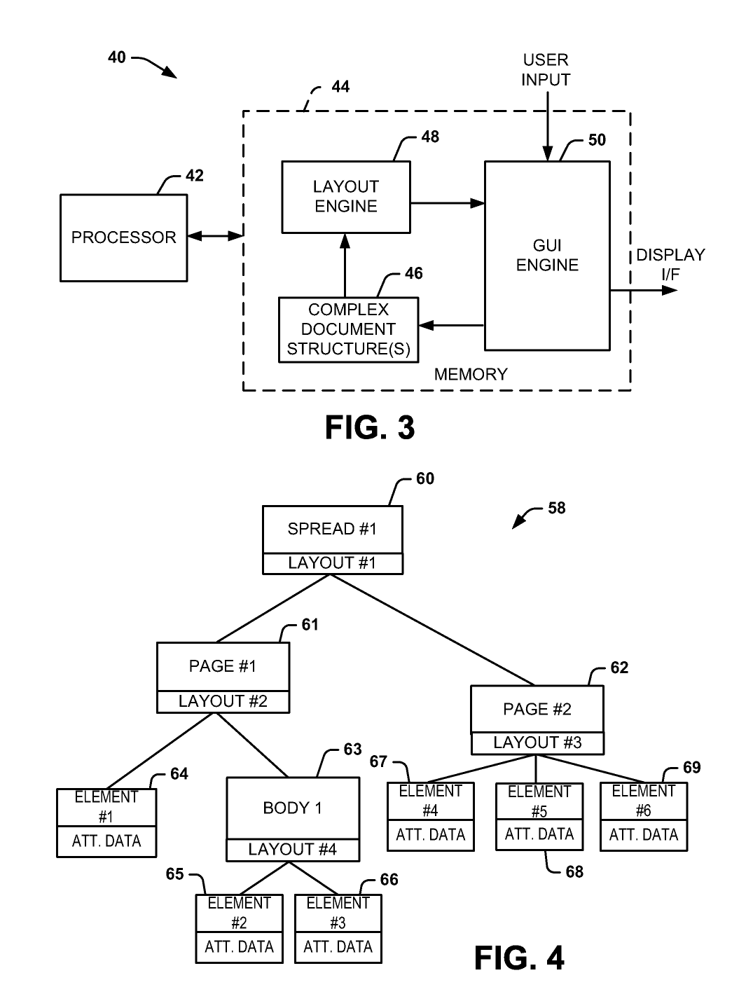

FIG. 3 illustrates a block diagram of an example system 40 for building complex documents employing feedforward indicators. The system 40 includes a processing unit 42 and memory 44. Memory 44 can be implemented as a computer readable medium, such as random access memory (RAM), non-volatile memory, etc. Memory 44 includes computer executable components and/or instructions in the form of a graphical user interface engine 50 and a layout engine 48. The memory 44 also includes a plurality of complex document element data structures 46 with each data structure representing a complex document to be displayed in browsers in a GUI displayed on a display. The processing unit 42 can access memory 44 and retrieve and update the data structures and also execute the computer executable components and/or instructions. The GUI engine 50 provides instructions to a display interface for displaying on a display a single user interface window that includes a target complex document browser and a plurality of source complex document browsers. Displayed within the target complex document browser and each of the plurality of source complex document browsers is an associated complex document that is displayed based on an associated complex document element data structure and an associated document layout defined by the layout engine 48.

The GUI engine 50 receives user input information, such as pointing, selecting and copying elements from the source complex document browsers to the target complex document browser, moving elements within the target complex document browser and flipping through pages of complex documents in the different complex document browsers. The GUI engine 50 then instructs the display interface to display the graphical operations to the user, such as pointing, selecting, dragging and dropping of elements, groups of elements or layout formats. During pointing to the elements, the GUI engine 50 provides a feedforward indicator, such as curling of ends of the elements or highlighting to provide the user with an indication that the element is selected for copying or moving.

During selecting and dragging of the element, the GUI engine 50 can provide a feedforward indicator of dragging a silhouette or shadow of the element from a source location to a target location. When the silhouette or shadow is at or near the target location, the GUI engine 50 provides feedforward indicators to an element or elements at the target location, such as curling ends of the element or elements or highlighting the elements and fading or moving elements to provide a user with an indication of which element or elements are to be affected by the drop operation and whether a replace or insertion action will ensue. Furthermore, a curling feedforward indicator of the element can be further selected to reveal attributes on the reverse side of the element, such that the GUI engine 50 provides the respective attributes of the element or group of elements, such as authorship, element type, price of using the element, etc from the respective data structures. The curling element also reveals other elements behind the elements such as background images and/or the containers beneath the elements.

The GUI engine 50 provides edits to the complex document structures 46 with indication information when an element has been added or moved to the target complex document within the target complex document browser. The layout engine 48 then processes the modified complex document element data structure associated with the target complex document and determines a layout constrained by the layout engine 48 to arrange the elements on a page or spread of the complex document. The arrangement may be statistically determined based on, for example, minimizing white space on a page or spread. The GUI engine 50 receives the layout instruction from the layout engine 48 and instructs the rearrangement of the elements associated with the different elements to be displayed on the display. A similar process occurs when a user provides an indication of moving elements within the target complex document.

FIG. 4 illustrates an example of a multi-level hierarchical data structure 58 corresponding to a spread. The data structure 58 can be represented as a binary tree having a plurality of container nodes 60-63 and a plurality of content nodes 64-69. In the example of FIG. 4, the content nodes 64-69 are implemented as leaf nodes corresponding to the container nodes 60-63. Each of the content elements includes associated attribute data, such as component type, component authorship and component revenue or cost. A given complex document can be formed of multiple spreads, which may be the same or different depending on the layout format of the container.

In the example of FIG. 4, the spread 60 includes a Layout Format #1, a first page container node 61 (“Page 1”) that includes a Layout Format #2 and a second page container node 62 (“Page 2”) that includes a Layout Format #3. The first and second page container nodes 61 and 62 are associated with the first and second pages, respectively, of the spread. Branching from the container node 61 are a leaf node 64 (Element #1) and another container node 63 (“Body 1”). The container node 63 includes a Layout Format #4 and further includes two child content nodes 65 and 66, demonstrated as Element #2 and Element #3. The container node 62 includes three child leaf content nodes 67-69, demonstrated as Element #4, Element #5 and Element #6. Each layout format can be fixed or dynamic. A dynamic format includes a layout engine and associated layout parameters that layouts elements within a container employing a statistical model or some other model. The example of FIG. 4 demonstrates but one example of a hierarchical representation for a spread that can be implemented in source complex document or a target complex document. Various other structures and content can be utilized based on the teachings herein.

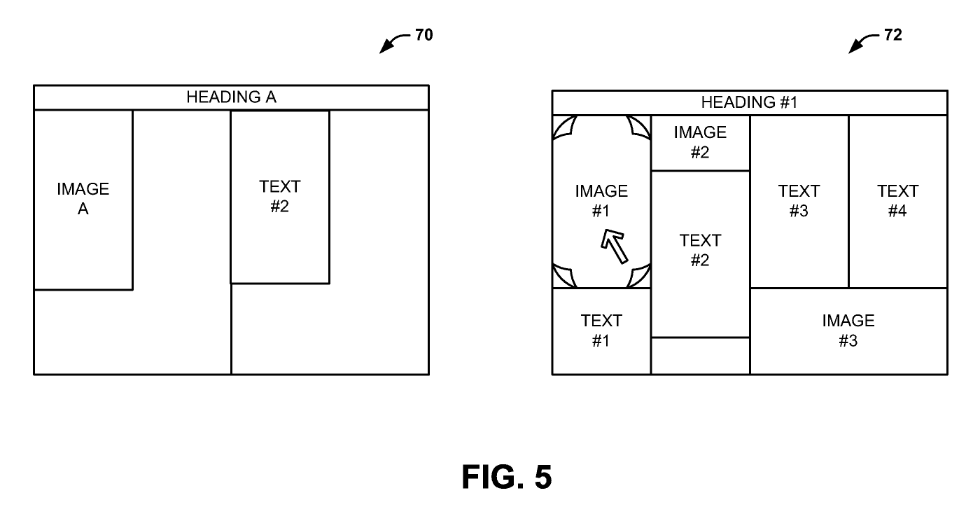

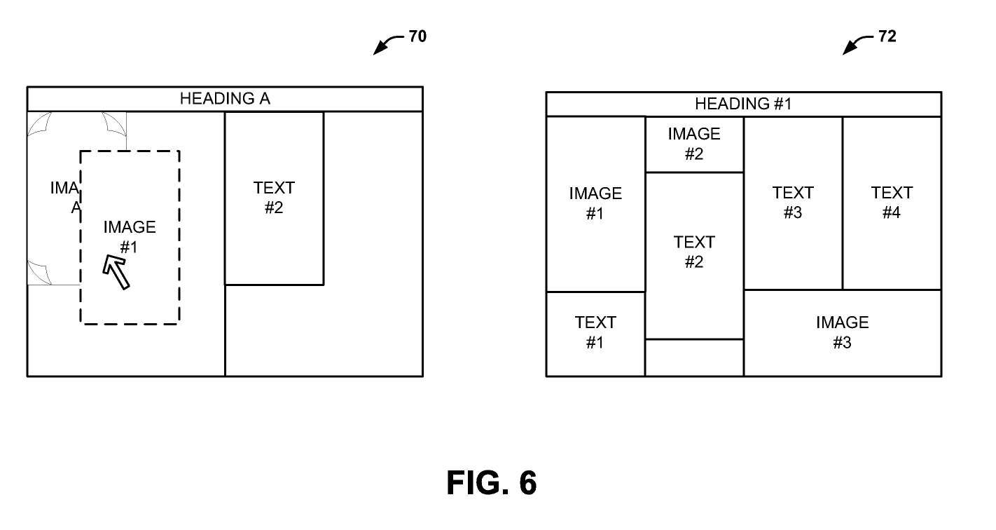

FIGS. 5-12 illustrate portions of a graphical user interface that show feedforward indicators during different user operations for building complex documents. FIG. 5 illustrates an example of a feedforward indicator during a user pointing operation to an element of a complex document. A source complex document 72 is displayed alongside a target complex document 70. A pointer is pointed to an image element #1 residing in the source complex document 72. Ends of the image element #1 are curled to provide an indication to a user that image element #1 is selected and active for copying. FIG. 6 illustrates an example of a feedforward indicator during a user drag operation of an element. A silhouette or shadow copy of the image element #1 is dragged via a pointer from the source complex document 72 over an element of the target complex document 70 which the user desires to replace with the image element #1. An image element A provides a feedforward indicator by curling of the ends of the image element A and a fading of image element A to provide a user with an indication that the image element A will be replaced by the image element #1 if the user performs the drop operation.

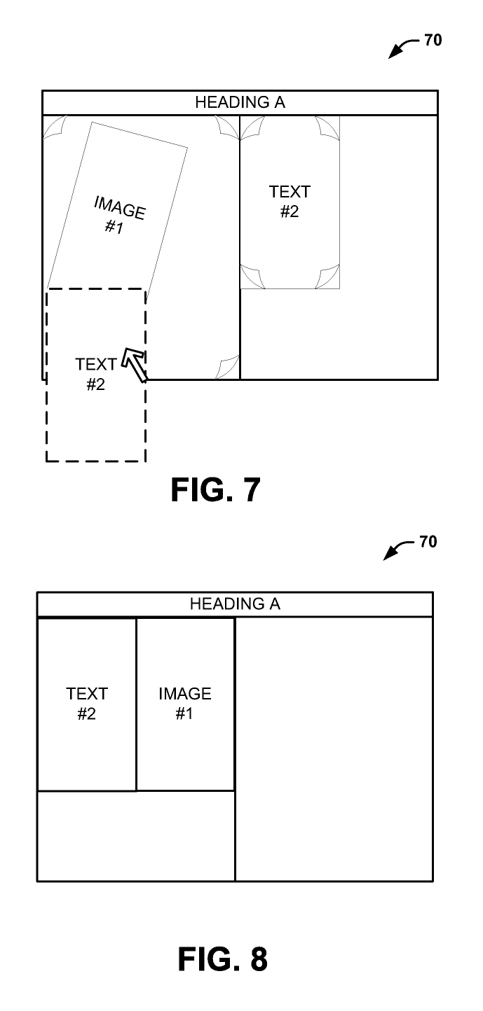

FIG. 7 illustrates an example of a feedforward indicator during a user move operation to move elements within an open space in the target complex document. A user drags a silhouette or shadow copy of the text element #2 via a pointer below image element #1 in the target complex document 70. The feedforward indication comprises a curling of the corners of the selected container and a rotation and movement of its elements to indicate that objects will be dropped into the container and will be inserted rather than causing a replacement of existing elements of the container. FIG. 8 illustrates the resultant GUI 70 after the text block #2 has been dropped via a user drop operation subsequent to the user drag operation of FIG. 7.

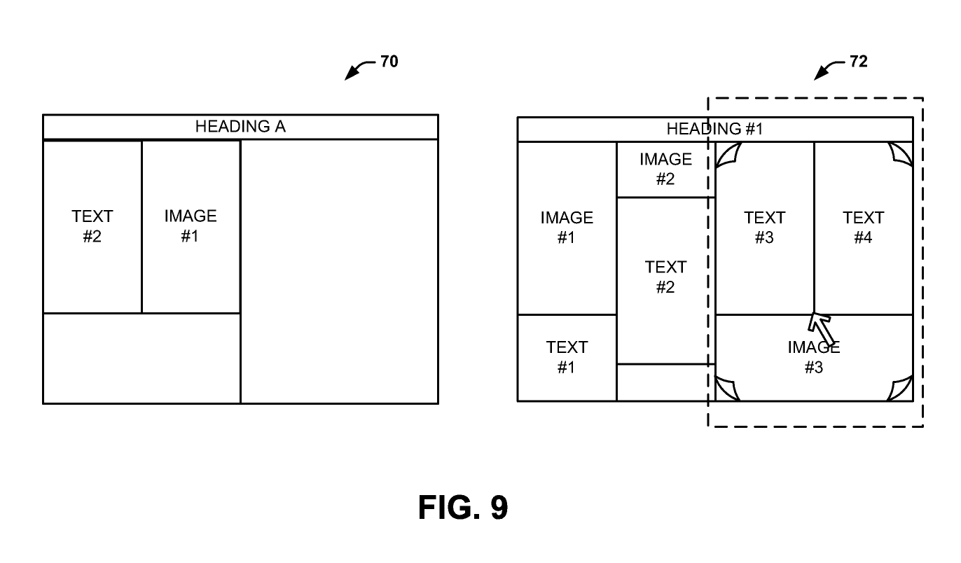

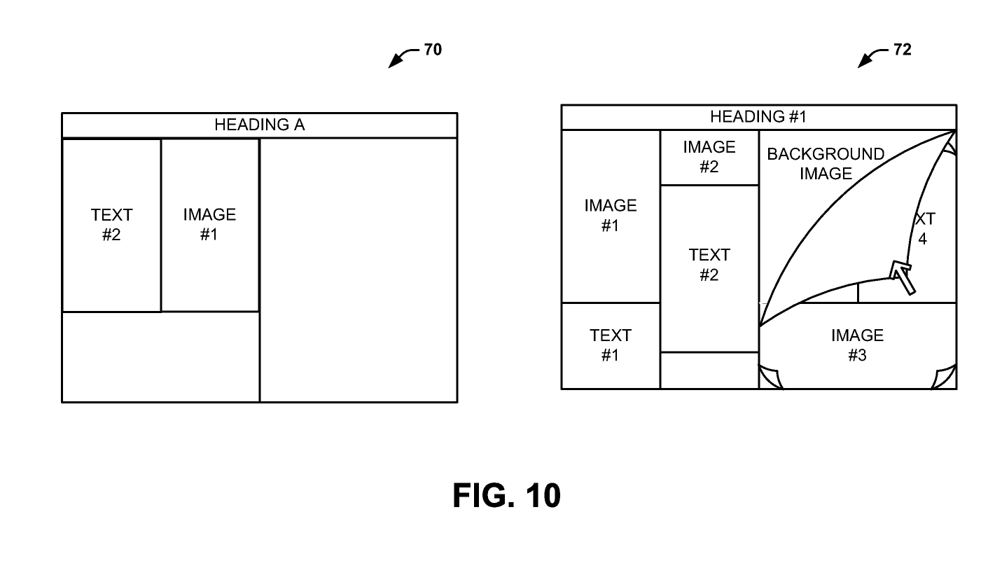

FIG. 9 illustrates an example of a feedforward indicator during a user pointing operation to a group of elements of a complex document. The source complex document 72 is displayed alongside the target complex document 70. A group of elements (text element #3, text element #4 and image element #3) are selected by either dragging around the group of elements or pointing a pointer at a center location of the group of elements or in the case where the elements belong to a container pointing to a space in the container or to a margin of the container or to a portion of the container revealed by curling of a corner of an element covering the container. Ends of the group of elements are curled to provide an indication to a user that the group of elements is selectable for copying. FIG. 10 illustrates an example of a secondary feedforward indicator during a user drag operation of a feedforward indicator of a group of elements (text element #3, text element #4 and image element #3) in the source complex document 72. A user drags a curled portion of the group of elements such that the curled portion is enlarged exposing a background image that resides behind the group of elements.

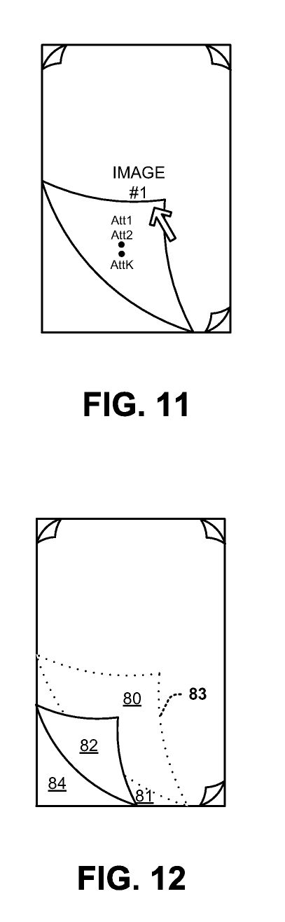

FIG. 11 illustrates an example of a secondary feedforward indicator during a user drag operation of a feedforward indicator of an element. A user drags a curled portion of the element image #1 such that the curled portion is enlarged exposing attributes (Att1-AttK, where K is an integer equal to or greater than one) associated with the element such as authorship, element type, price of the element, etc. This provides a user with a feedforward indication of what attributes that the element is associated, so that the user can make a determination of whether or not to copy the element. For example, a subsequent cost of copying the element if the user performs a publishing operation. FIG. 12 illustrates the curled corner of a selected element 80 revealing other elements 81 or containers beneath it. Moving the cursor into the revealed region selects the revealed element or container. This is indicated by the curling of the corner 82 of the revealed region. The corner of the original covering element 80 remains curled back but its appearance is changed, for example by making the outline 83 intermittent, to indicate that it is no longer the selected element. With the corner of the first revealed region 82 curled back the cursor can be moved into the new revealed region 84. The corner of this region now curls back to indicate selection. This process can be repeated as often as necessary to select objects in lower layers of the document.

It is to be appreciated that FIGS. 5-12 illustrate examples of feedforward indicators that can be employed for providing a user with feedforward indications so that the user can make informed decisions when building complex documents and that a variety of different feedforward indicators can be provided for a variety of different features for building complex documents.

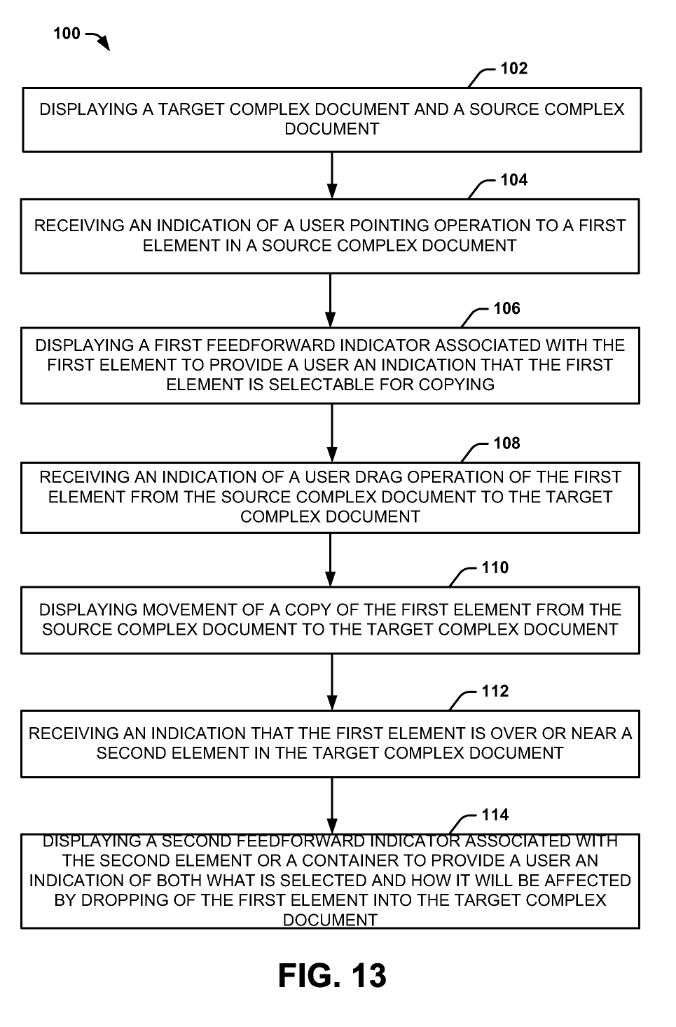

In view of the foregoing structural and functional features described above, an example methodology will be better appreciated with reference to FIG. 13. While, for purposes of simplicity of explanation, the example method of FIG. 13 is shown and described as executing serially, it is to be understood and appreciated that the present example is not limited by the illustrated order, as some actions could in other examples occur in different orders and/or concurrently from that shown and described herein.

FIG. 13 illustrates a flow chart of an example method 100 for building a complex document employing feedforward indicators. The method 100 could be executed, for example, by processor. At 102, a target complex document and a source complex document are displayed. At 104, an indication is received of a user pointing operation to a first element in a source complex document. At 106, a first feedforward indicator associated with the first element is displayed to provide a user an indication that the first element is selected and is to be copied. At 108, an indication is received of a user drag operation of the first element from the source complex document to the target complex document. At 110, movement of a copy of the first element from the source complex document to the target complex document is displayed. At 112, an indication is received that the first element is over or near a second element in the target complex document. At 114, a second feedforward indicator associated with the second element or a container is displayed to provide a user an indication of both what is selected and how it is affected by dropping the first element into the target complex document.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system for building complex documents, the system comprising:
a memory for storing computer executable instructions; and
a processing unit for accessing the memory and executing the computer executable instructions, the computer executable instructions comprising:
a graphical user interface engine to display a complex document and to display a feedforward indicator associated with an element in the complex document in response to a first user operation, the feedforward indicator provides a user with an indication of affects to the complex document associated with a second user operation.

2. The system of claim 1, the graphical user interface engine to display a second feedforward indicator in response to a third user operation on the feedforward indicator.

3. The system of claim 1, wherein the feedforward indicator provides a user an indication of an element that is selected for copying in response to a user pointing operation on the element in the complex document.

4. The system of claim 2, wherein the feedforward indicator comprises ends of the elements curling in response to a user pointing operation on the element and a curled portion of an end of the elements is expanded in response to a user drag operation on the curled portion to expose a layer of the complex document beneath the element.

5. The system of claim 4, wherein the graphical user interface engine to display attributes on the exposed layer or on a back surface of the element in response to a user drag operation on the curled portion.

6. The system of claim 1, the graphical user interface engine to display a group feedforward indicator in response to a user operation on a group of elements.

7. The system of claim 1, the graphical user interface engine to display feedforward indicators that illustrate what elements are to be affected and how elements are to be affected in response to a drop operation of the element into a complex document.

8. The system of claim 1, the element being a first element and the feedforward indicator being a first feedforward indicator, the graphical user interface engine to display a source complex document and a target complex document, such that elements from the source complex document are copyable to the target complex document, the graphical user interface engine to display a second feedforward indicator associated with a second element in the target complex document in response to a user operation associated with the first element that affects the current location of the second element.

9. The system of claim 8, wherein the user operation associated with the first element that affects the second element is a drag operation of the first element over or near the second element to replace or move the second element and copy the first element into the target complex document, the graphical user interface engine to display curling of ends of the second element in response to the drag operation of the first element over or near the second element and to display a silhouette or shadow of the first element from the source complex document to the target complex document during the drag operation and to display a silhouette or shadow of the second element in a new location in response to a move operation.

10. A method for building complex documents, the method comprising:
displaying a target complex document and a source complex document;
receiving an indication of a user pointing operation to a first element in a source complex document;
displaying a first feedforward indicator associated with the first element to provide a user an indication that the first element is selected for copying;
receiving an indication of a user drag operation of the first element from the source complex document to the target complex document;
displaying movement of a copy of the first element from the source complex document to the target complex document;
receiving an indication that the first element is over or near a second element in the target complex document; and
displaying a second feedforward indicator associated with the second element or a container to provide a user an indication of both what is selected and how it is to be affected by dropping the first element into the target complex document.

11. The method of claim 10, wherein the displaying movement of a copy of the first element from the source complex document to the target complex document comprises displaying a silhouette or shadow copy of the element.

12. The method of claim 9, wherein the first feedforward indicator comprises curling ends of the first element and the second feedforward indicator comprise curling ends of the second element.

13. A computer readable medium having computer executable instructions comprising:
a graphical user interface engine to display a complex document and to display a first feedforward indicator associated with an element in the complex document in response to a first user operation, the feedforward indicator provides a user with an indication of results associated with a second user operation on the element and the graphical user interface engine to display a second feedforward indicator in response to a third user operation on the first feedforward indicator.

14. The computer readable medium of claim 13, wherein the first user operation is a pointing operation and the first feedforward indicator comprises ends of the element curling in response to the first operation, the second user operation is a copy operation, and the third user operation is a dragging operation of the curled portion of an end of the element and the second feedforward indicator is attributes associated with the element.

15. The computer readable medium of claim 14, the graphical user interface engine to display a second complex document and to display ends of an element in the second complex document curling in response to a copy of an element being over or near the element in the second complex document.
